(19) United States
(12) Patent Application Publication
(10) Pub. No.: US 2008/0012868 A1
(43) Pub. Date: Jan. 17, 2008

(54) Multimedia Playback System, Multimedia Data Reproduction Apparatus, and Method Thereof

(75) Inventor: Sung-Yi Tsai, Taitung County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsin-Chu City (TW)

(21) Appl. No.: 11/457,576

(22) Filed: Jul. 14, 2006

(51) Int. Cl. G06T 1/60

(52) U.S. Cl. 345/530; 345/667

(57) ABSTRACT

A multimedia data reproduction apparatus comprises the following: a resizer for resizing a decoded multimedia data according to information corresponding to a display definition; a memory for storing the resized multimedia data; and a memory controller for allocating the memory to store the resized multimedia data according to the information. The memory controller can allocate the memory in response to various display definitions.

### CROSS-REFERENCES TO RELATED APPLICATIONS

Not Applicable

### BACKGROUND OF THE INVENTION

1. Field of the Invention

The present invention relates to a multimedia playback system, a multimedia data reproduction apparatus, and a method thereof; in particular, relates to a system, an apparatus, and a method for dynamically adjusting the size of multimedia data during display.

2. Descriptions of the Related Art

Generally, most multimedia data players of the prior art comprise an internal memory, for example, a DRAM. The internal memory is configured to temporarily store to-be-played data, which is then transmitted to an output stage in response to a playback signal. The output stage consequently sends the data to a display device to visually form a picture. However, multimedia files are getting increasingly larger. For example, many consumer digital cameras in the current market can support image files with a definition of 6 million pixels. In other words, one image file occupies 6 Mb memory space. Another example is an LCD TV. An image displayed on a 32-inch LCD TV has a definition of about 1400×768 pixels; therefore, each full screen image occupies about 1 Mb memory space. Since internal memory space is limited, a conventional method of solving this problem includes storing the multimedia files with low definition and arranging a scaler in the output stage to scale the multimedia files from low definition to high definition. However, a file with a low definition carries little information; therefore, details are not shown when the image is scaled-up. In other words, the scaled-up image becomes vague.

Accordingly, a solution to displaying multimedia data with a suitable size on a display device is desired in the industry.

### SUMMARY OF THE INVENTION

An object of this invention is to provide a multimedia data reproduction apparatus. The multimedia data reproduction apparatus comprises a resizer, a memory, and a memory controller. The resizer is configured to resize a decoded multimedia data according to information corresponding to a display definition. The memory is configured to store the resized multimedia data. The memory controller is configured to allocate the memory to store the resized multimedia data according to the information.

Another object of this invention is to provide a method for reproducing multimedia data. The method comprises steps of: resizing a decoded multimedia data according to information corresponding to a display definition; allocating a memory according to the information; and storing the resized multimedia data in the memory according to the allocation.

Another object of this invention is to provide a multimedia playback system. The multimedia playback system comprises a resizer, a memory, a memory controller, and a display device. The resizer is configured to resize a decoded multimedia data according to information corresponding to a display definition. The memory is configured to store the resized multimedia data. The memory controller is configured to allocate the memory to store the resized multimedia data according to the information. The display device is configured to display the resized multimedia data.

Another object of this invention is to provide a multimedia data reproduction apparatus. The multimedia data reproduction apparatus comprises: means for resizing a decoded multimedia data according to information corresponding to a display definition; means for storing the resized multimedia data; and means for allocating the memory to store the resized multimedia data according to the information.

The present invention can dynamically adjust the available space of memory for various-resized inputted multimedia data. The utility rate of the memory is improved thereby. In addition, the resolution of the inputted multimedia data during display is also improved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a first embodiment in accordance with the present invention; and

FIG. 2 shows a flow chart of a second embodiment in accordance with the present invention.

### DESCRIPTION OF THE PREFERRED EMBODIMENT

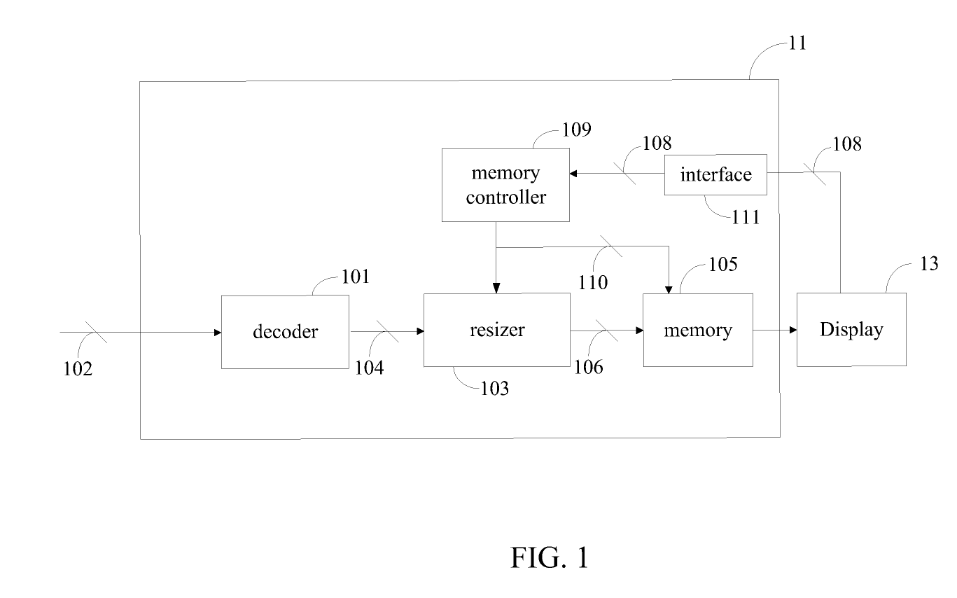

A first embodiment of the present invention is a multimedia playback system for playing multimedia data, such as video data or still image data, as shown in FIG. 1. The multimedia playback system comprises a multimedia data reproduction apparatus 11 and a display device 13. The multimedia data reproduction apparatus 11 comprises a decoder 101, a resizer 103, a memory 105, a memory controller 109, and an interface 111. The decoder 101 receives a video/image bitstream 102 and decodes the bitstream 102 into a decoded multimedia data 104. The memory controller 109, also referred to as a reduced instruction set computer (RISC) controller in the first embodiment, receives information 108 from the interface 111. The interface 111, which is high-definition multimedia interface (HDMI) compatible, is coupled to the display device 13. The information 108 carries the display definition of the display device 13. In other preferred embodiments, the information 108 may be inputted manually by user.

When the display definition is changed, the memory controller 109 transmits a signal 110 to the resizer 103. The resizer 103 resizes the decoded multimedia data 104 to generate a resized multimedia data 106 in response to the signal 110. The signal 110 is also transmitted to the memory 105 so the memory 105 can be allocated with appropriate space to store the resized multimedia data 106.

More particularly, the first embodiment is capable of allocating the memory 105 for multimedia data with different definitions. The memory 105, generally a DRAM, consists of many partitions. When the display definition is changed to a higher definition, the memory controller 109 assigns more partitions for the resized multimedia data 106 to store. For example, if the display definition is changed from 480P to 1080I, the partitions for storing the resized multimedia data 106 are adjusted from 720×480×N bytes to 1080×1920×N bytes, wherein N=1.5 for YCrCb=4:2:0, and N=2 for YCrCb=4:2:2. When the display definition is changed to a lower definition, the memory controller 109 assigns fewer partitions for the resized multimedia data 106 to store.

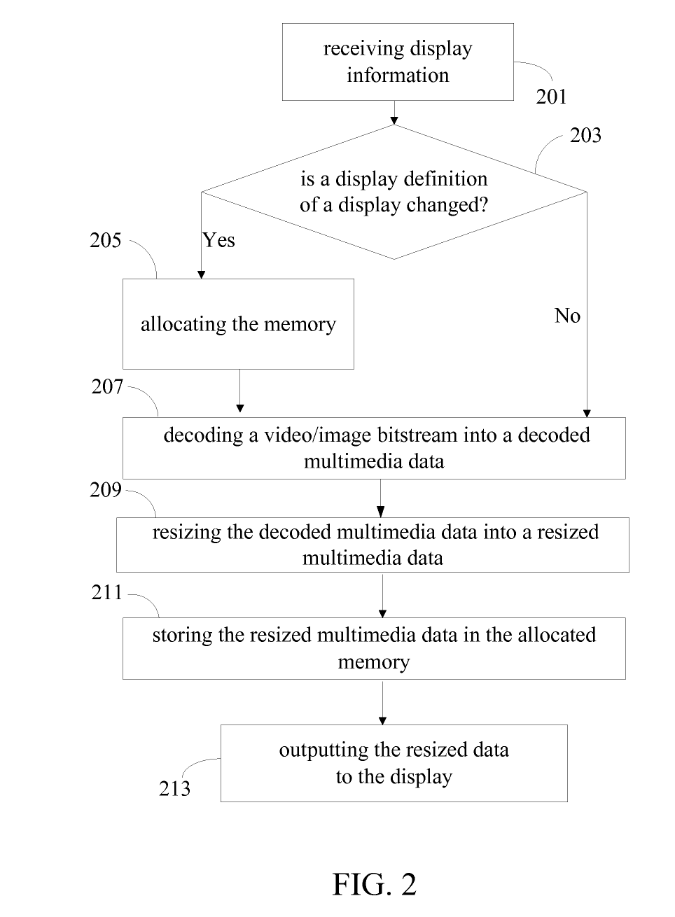

A second embodiment of the present invention is a method adapted for a multimedia playback system like the first embodiment. FIG. 2 shows a flow chart of the second embodiment. The multimedia playback system has two options for a display definition: standard definition (SD) and high definition (HD). The two options are only provided to illustrate the second embodiment and are not limitations of the present invention. In step 201, a memory controller, such as the memory controller 109, receives information indicating the display definition is SD or HD. In step 203, the memory controller determines if the display definition of a display device, such as the display device 13, is changed, for example, from SD to HD or from HD to SD based on the information. If yes, step 205 is executed, wherein the memory controller allocates the memory. In step 207, a decoder, such as the decoder 101, decodes a video/image bitstream into a decoded multimedia data. In step 209, a resizer, such as the resizer 103, resizes the decoded multimedia data into a resized multimedia data. In step 211, the resized multimedia data is temporarily stored in the allocated memory. In step 213, the resized multimedia data is outputted to the display device. If the display definition is determined not changed in step 203, step 207 is executed. It is noted that the sequence of the aforementioned steps is just an example. In other words, the sequence of the steps is not a limitation of the present invention.

The present invention can dynamically adjust the available space of the memory for various-resized multimedia data. The utility rate of the memory is improved thereby. In addition, the resolution of the multimedia data during display is high.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A multimedia data reproduction apparatus comprising:
a resizer for resizing a decoded multimedia data according to information corresponding to a display definition;
a memory for storing the resized multimedia data; and
a memory controller for allocating the memory to store the resized multimedia data according to the information.

2. The multimedia data reproduction apparatus as claimed in claim 1, wherein the decoded multimedia data is a video data.

3. The multimedia data reproduction apparatus as claimed in claim 1, wherein the decoded multimedia data is a still image data.

4. The multimedia data reproduction apparatus as claimed in claim 1, wherein the memory controller is a reduced instruction set computer (RISC) controller.

5. The multimedia data reproduction apparatus as claimed in claim 1, wherein the information is inputted manually.

6. The multimedia data reproduction apparatus as claimed in claim 1, wherein the information is inputted automatically.

7. The multimedia data reproduction apparatus as claimed in claim 6, wherein the information is received from an interface coupled to a display device.

8. The multimedia data reproduction apparatus as claimed in claim 7, wherein the interface is high-definition multimedia interface (HDMI) compatible.

9. The multimedia data reproduction apparatus as claimed in claim 1, further comprising a decoder for generating the decoded multimedia data.

10. A method for reproducing multimedia data, comprising steps of:
resizing a decoded multimedia data according to information corresponding to a display definition;
allocating a memory according to the information; and
storing the resized multimedia data in the memory according to the allocation.

11. The method as claimed in claim 10, wherein the decoded multimedia data is a video data.

12. The method as claimed in claim 10, wherein the decoded multimedia data is a still image data.

13. The method as claimed in claim 10, wherein the allocating step is performed by a RISC controller.

14. The method as claimed in claim 10, wherein the information is inputted manually.

15. The method as claimed in claim 10, wherein the information is inputted automatically.

16. The method as claimed in claim 15, further comprising a step of:
providing an interface coupled to a display device;
wherein the information is received from interface.

17. The method as claimed in claim 16, wherein the interface is HDMI compatible.

18. The method as claimed in claim 10, further comprising a step of:
generating the decoded multimedia data.

19. A multimedia playback system, comprising:
a resizer for resizing a decoded multimedia data according to information corresponding to a display definition;
a memory for storing the resized multimedia data; and
a memory controller for allocating the memory to store the resized multimedia data according to the information; and
a display device for displaying the resized multimedia data.

20. A multimedia data reproduction apparatus, comprising:
means for resizing a decoded multimedia data according to information corresponding to a display definition;
means for storing the resized multimedia data; and
means for allocating the memory to store the resized multimedia data according to the information.

21. The multimedia data reproduction apparatus as claimed in claim 20, wherein the decoded multimedia data is a video data.

22. The multimedia data reproduction apparatus as claimed in claim 20, wherein the decoded multimedia data is a still image data.

23. The multimedia data reproduction apparatus as claimed in claim 20, wherein the allocating means is a RISC controller.

24. The multimedia data reproduction apparatus as claimed in claim 20, wherein the information is inputted manually.

25. The multimedia data reproduction apparatus as claimed in claim 20, wherein the information is inputted automatically.

26. The multimedia data reproduction apparatus as claimed in claim 25, further comprising means for connecting to a display device, wherein the information is received from the connecting means.

27. The multimedia data reproduction apparatus as claimed in claim 26, wherein the connecting means is HDMI compatible.

28. The multimedia data reproduction apparatus as claimed in claim 20, further comprising means for generating the decoded multimedia data.
